(19) United States
(12) Patent Application Publication
(10) Pub. No.: US 2009/0159015 A1
(43) Pub. Date: Jun. 25, 2009

(54) Animal Collar

(76) Inventor: Jason Watson, Charlotte, NC (US)

Correspondence Address: WILLIAMS MULLEN, 222 CENTRAL PARK AVENUE, SUITE 1700, VIRGINIA BEACH, VA, 23462, US

(21) Appl. No.: 11/963,305

(22) Filed: Dec. 21, 2007

(51) Int. Cl. A01K 27/00

(52) U.S. Cl. 119/858; 119/863

(57) ABSTRACT

An animal collar according to the present invention includes an inner layer of non-porous flexible plastic. The collar may also include an outer layer of non-porous flexible plastic molded over the inner layer of non-porous flexible plastic, the outer layer having first and second ends and being configured to encircle a neck of an animal. A clasp or other fastener may be included for coupling together the first and second ends about the animal's neck. In addition, the inner layer includes an aesthetic property such as a color. The outer layer may also have an aesthetic property such as another color that is different from the aesthetic property of the inner layer. The collar may also include at least one ornament, the inner layer being molded over the at least one ornament and separating it from the outer layer.

### BACKGROUND OF THE INVENTION

This invention relates generally to pet products and, more particularly, to an animal color that is flexible and non-porous for virtually eliminating bacteria and odor and for lengthening the durability of the collar. In addition, the present invention provides an animal collar having a construction that enables enhanced design options.

Almost all dogs are fitted with a collar, whether for holding an identification tag, providing a mount for a leash, or even to release a pest repellant over time. Many collars are constructed of fabric materials in order to maintain flexibility. Although assumably effective for their intended purposes, such collars become wet when exposed to rain and the like and become a haven for bacteria that subsequently results in a very negative odor. In addition, the existing collars typically do not include a construction that provides contemporary design enhancements.

Therefore, it would be desirable to have an animal collar having a non-porous construction that sheds water rather than becoming soaked by moisture. Further, it would be desirable to have an animal collar having a flexible plastic construction that is flexible so as to comfortably fit around the neck of an animal. In addition, it would be desirable to have an animal collar having either more than one layer of nonporous flexible plastic material or an ornament separated from one another through an over-molding process so as to enhance the design configuration.

### SUMMARY OF THE INVENTION

Accordingly, an animal collar according to the present invention includes an inner layer of non-porous flexible plastic. The collar may also include an outer layer of non-porous flexible plastic molded over the inner layer of non-porous flexible plastic, the outer layer having first and second ends and being configured to encircle a neck of an animal. A clasp or other fastener may be included for coupling together the first and second ends about the animal's neck. In addition, the inner layer includes an aesthetic property such as a color. The outer layer may also have an aesthetic property such as another color that is different from the aesthetic property of the inner layer. The collar may also include at least one ornament, the inner layer being molded over the at least one ornament and separating it from the outer layer.

Therefore, a general object of this invention is to provide an animal collar having a non-porous construction that sheds water so as to minimize bacteria and odor.

Another object of this invention is to provide an animal collar, as aforesaid, that is durable.

Still another object of this invention is to provide an animal collar, as aforesaid, that is flexible for comfortably extending around the neck of an animal.

Yet another object of this invention is to provide an animal collar, as aforesaid, that is constructed using an over-molding process that provides multiple aesthetic enhancements.

A further object of this invention is to provide an animal collar, as aforesaid, that is inexpensive to manufacture and user-friendly to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an animal collar according to the preferred embodiment of the present invention;

FIG. 2a is a perspective view of an empty mold for use in constructing the animal collar as in FIG. 1;

FIG. 2b is a perspective view of the mold as in FIG. 2a in use with the collar of FIG. 1;

FIG. 3a is a top view of the empty mold as in FIG. 2a;

FIG. 3b is a sectional view taken along line 3b-3b of FIG. 3a;

FIG. 3c is an isolated view on an enlarged scale taken from FIG. 3b;

FIG. 4a is a top view of the animal collar as in FIG. 1;

FIG. 4b is a sectional view taken along line 4b-4b of FIG. 4a; and

FIG. 4c is an isolated view on an enlarged scale taken from FIG. 4b.

### DESCRIPTION OF THE PREFERRED EMBODIMENT

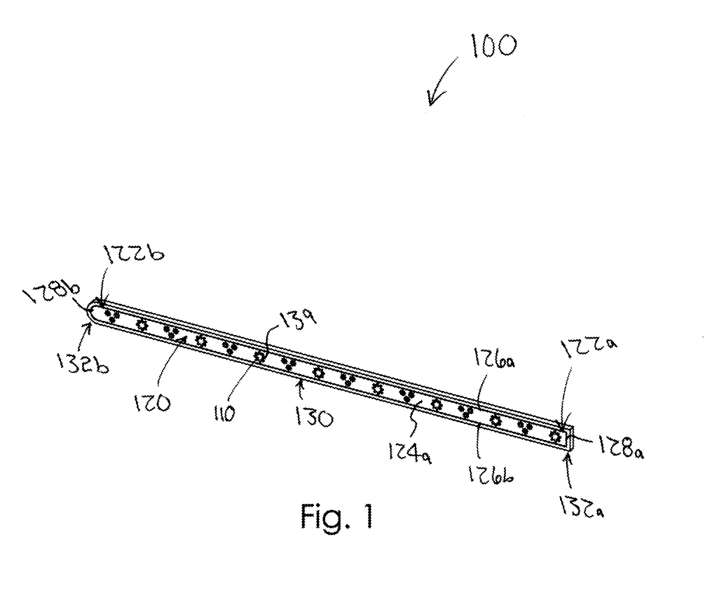

A collar 100 according to the present invention will now be described in detail with reference to FIGS. 1 through 4c of the accompanying drawings. More particularly, according to the current invention, a collar 100 for use with an animal includes at least one ornament 110 and layer 120 of non-porous flexible plastic.

The ornament 110 may be constructed of non-porous flexible plastic or other appropriate materials and may have any ornamental shape and/or color. A suitable non-porous flexible plastic for the ornament 110 is polyvinyl chloride combined with a plasticizer, though other materials may alternately (or additionally) be used.

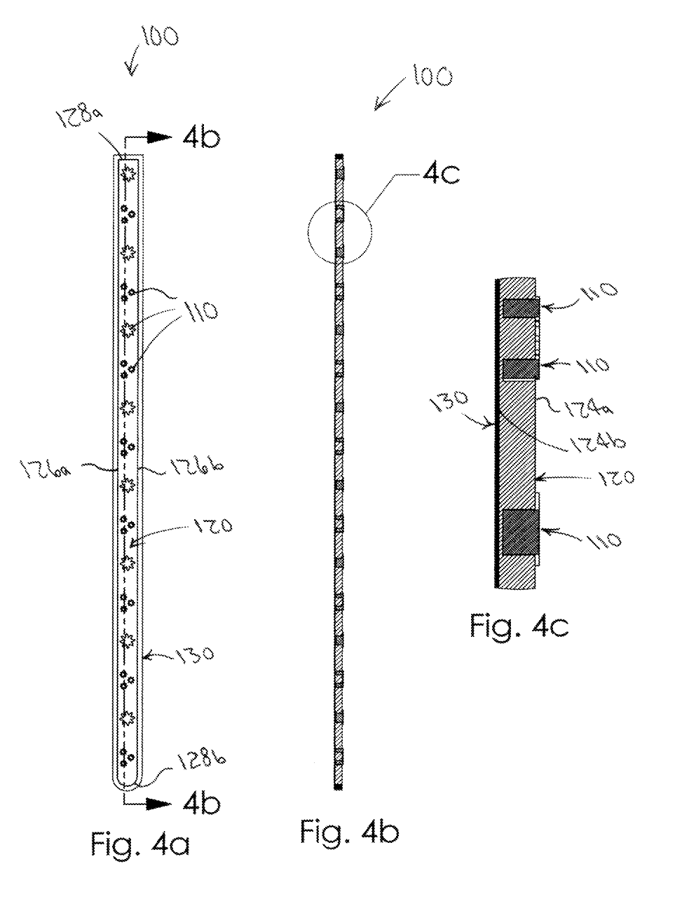

The layer 120 of non-porous flexible plastic is also referred to herein as the “first layer” and the “inner layer”. As shown in FIG. 1, the first layer 120 may be elongate, and the first layer 120 may be coupled to the ornament 110 (FIG. 4c). More particularly, the first layer 120 may be molded over the ornament 110, or in other words, coupled to the ornament 110 by an overmolding process. The first layer 120 may have first and second ends 122a, 122b, front and rear faces 124a, 124b, a pair of sidewalls 126a, 126b, and a pair of endwalls 128a, 128b and may be configured (e.g., have an appropriate length and width) to encircle a neck of an animal (e.g., a dog, cat, etc.), as shown in FIGS. 1, 4b, and 4c (though the animal is not shown). Further, the first layer 120 may include an aesthetic property such as a color, design, pattern, etc.

A suitable non-porous flexible plastic for the first layer 120 is polyvinyl chloride combined with a plasticizer, though other materials may alternately (or additionally) be used. Especially if polyvinyl chloride combined with a plasticizer is used, the aesthetic property of the first layer 120 may be introduced into the material, as polyvinyl chloride generally does not bond well to most paints once it becomes set.

As shown in FIGS. 1, 4b, and 4c, a layer 130 (also referred to herein as the second layer and the outer layer, though additional layers could be “outside” layer 130) of non-porous flexible plastic may be molded over the first layer 120, or in other words, coupled to the first layer 120 by an overmolding process. The second layer 130 may have first and second ends 132a, 132b and may be configured (e.g., have an appropriate length and width) to encircle a neck of an animal (e.g., a dog, cat, etc.), as shown in FIG. 1 (though the animal is not shown). The second layer 130 may abut the rear face 124b of the first layer 120, and the rear face 124b of the first layer 120 may separate the ornament 110 and the second layer 130 (FIG. 4c). As shown in FIGS. 4a and 4b, the second layer 130 may extend adjacent the sidewalls 126a, 126b and endwalls 128a, 128b of the first layer 120. A gap 139 (FIG. 1) may separate the second layer 130 from the sidewalls 126a, 126b and endwalls 128a, 128b of the first layer 120, as discussed in more detail below, and the second layer 130 may include an aesthetic property such as a color, design, pattern, etc. The aesthetic property of the second layer 130 may be different than the aesthetic property of the first layer 120.

A suitable non-porous flexible plastic for the second layer 130 is polyvinyl chloride combined with a plasticizer, though other materials may alternately (or additionally) be used. Especially if polyvinyl chloride combined with a plasticizer is used, the aesthetic property of the second layer 130 may be introduced into the material, as polyvinyl chloride generally does not bond well to most paints once it becomes set.

Means for selectively coupling together the first and second ends 122a, 122b of the first layer 120 and/or the first and second ends 132a, 132b of the second layer 130 may be included. For example, a clasp assembly or other fastener may be coupled to the first layer 120 and/or the second layer 130 (such as through riveting, the molding process, etc.) so that the first and/or second layer 120, 130 can be fastened around an animal's neck.

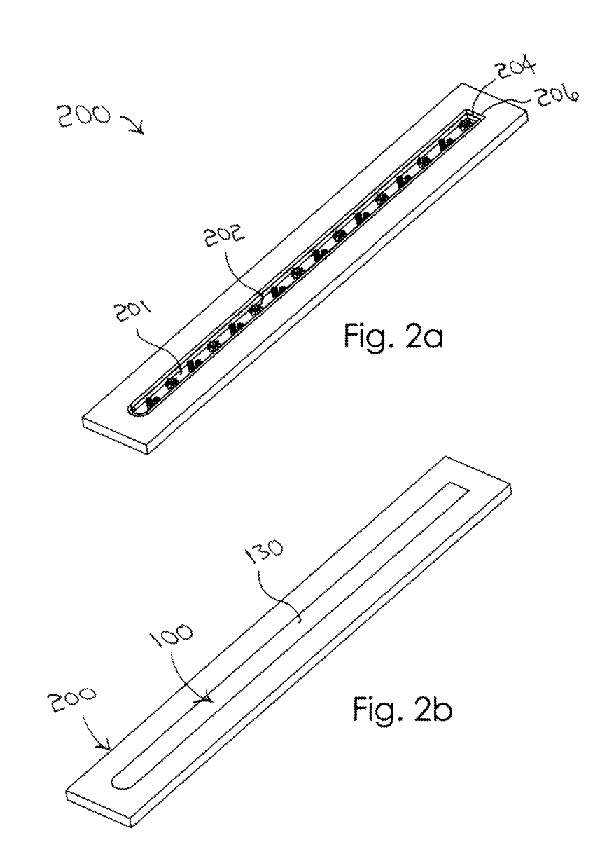

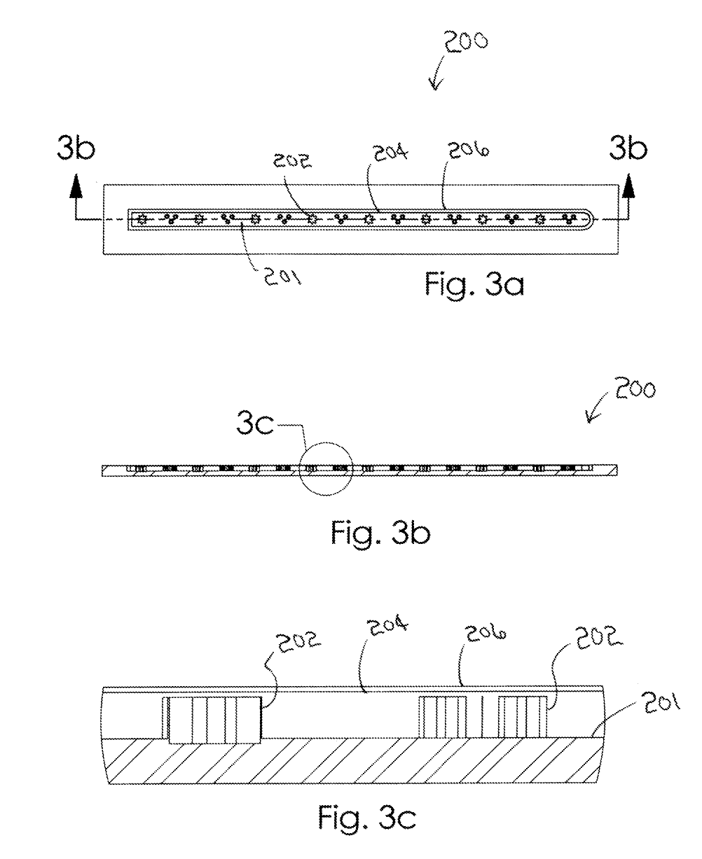

FIGS. 2a through 3c demonstrate one way to construct the collar 100 using a mold 200. The mold 200 has a base 201, a plurality of walls 202 that define cavities for the ornaments 110, a wall 204 that defines a cavity for the first layer 120, and an outer wall 206 that defines a cavity for the second layer 130 (FIG. 2a). FIG. 3c shows the walls 202 being shorter than the wall 204, and the wall 204 being shorter than the wall 206. A non-porous flexible plastic for the ornament 110 (e.g., polyvinyl chloride combined with a plasticizer) may be introduced into the cavity defined by the walls 202, and once that material has hardened a sufficient amount, a non-porous flexible plastic for the first layer 120 (e.g., polyvinyl chloride combined with a plasticizer) may be introduced to the cavity defined by the wall 204. Once the material for the first layer 120 has hardened a sufficient amount, a non-porous flexible plastic for the second layer 130 (e.g., polyvinyl chloride combined with a plasticizer) may be introduced to the cavity defined by the wall 206 (FIG. 2b). Such a method may result in the collar 100 described above, and particularly a collar 100 having a first layer 120 molded over an ornament 110, a second layer 130 molded over the first layer 120, and a plurality of aesthetic properties. The gap 139 may be formed by the wall 204.

In use, the collar 100 may be placed about an animal's neck, and the fastener may couple the ends 122a, 122b and/or 132a, 132b together as described above. The non-porous nature of the plastic used to construct the collar 100 may eliminate the potential for bacteria and undesirable odors, and the ornament 110 and multiple layers 120, 130 may make the collar 100 aesthetically pleasing.

It is understood that while certain forms of this invention have been illustrated and described, it is not limited thereto except insofar as such limitations are included in the following claims and allowable functional equivalents thereof.

1. A collar for use with an animal, comprising:
at least one ornament;
an elongate first layer of non-porous flexible plastic coupled to said at least one ornament by an overmolding process, said first layer having first and second ends and being configured to encircle a neck of said animal; and
means for selectively coupling together said first and second ends.

2. The collar as in claim 1, wherein said non-porous flexible plastic includes polyvinyl chloride and a plasticizer.

3. The collar as in claim 1, further comprising a second layer of non-porous flexible plastic coupled to said first layer by an overmolding process.

4. The collar as in claim 3, wherein:
said first layer has an aesthetic property; and
said second layer has an aesthetic property different than said first layer aesthetic property.

5. The collar as in claim 4, wherein:
said non-porous flexible plastic of said first layer includes polyvinyl chloride and a plasticizer; and
said non-porous flexible plastic of said second layer includes polyvinyl chloride and a plasticizer.

6. The collar as in claim 5, wherein said at least one ornament includes polyvinyl chloride and a plasticizer.

7. A collar for use with an animal, comprising:
at least one ornament;
a first layer of non-porous flexible plastic coupled to said at least one ornament by an overmolding process, said first layer having front and rear faces, a pair of sidewalls, and a pair of endwalls;
a second layer of non-porous flexible plastic coupled to said first layer by an overmolding process, said second layer having first and second ends and being configured to encircle a neck of said animal; and
means for selectively coupling together said first and second ends.

8. The collar as in claim 7, wherein said second layer extends adjacent said first layer sidewalls and said first layer endwalls.

9. The collar as in claim 8, wherein a gap separates said second layer from said first layer sidewalls and said first layer endwalls.

10. The collar as in claim 7, wherein said first layer rear face separates said ornament and said second layer.

11. The collar as in claim 7, wherein:
said first layer of non-porous flexible plastic is a layer of polyvinyl chloride combined with a plasticizer; and
said second layer of non-porous flexible plastic is a layer of polyvinyl chloride combined with a plasticizer.

12. The collar as in claim 11, wherein:
said first layer has an aesthetic property; and
said second layer has an aesthetic property different than said first layer aesthetic property.

13. The collar as in claim 12, wherein:
said second layer extends adjacent said first layer sidewalls and said first layer endwalls;
a gap separates said second layer from said first layer sidewalls and said first layer endwalls; and
said first layer rear face separates said ornament and said second layer.

14. A collar, comprising:
an inner layer of non-porous flexible plastic;
an outer layer of non-porous flexible plastic molded over said inner layer of non-porous flexible plastic, said outer layer having first and second ends and being configured to encircle a neck of an animal;
means for selectively coupling together said first and second ends;
wherein said inner layer has an aesthetic property; and
wherein said outer layer has an aesthetic property different than said inner layer aesthetic property.

15. The collar as in claim 14, further comprising at least one ornament, said inner layer being molded over said at least one ornament and separating said at least one ornament from said outer layer.

16. The collar as in claim 14, wherein:
said inner layer has front and rear faces, a pair of sidewalls, and a pair of endwalls;
said outer layer extends adjacent said inner layer sidewalls and said inner layer endwalls;
a gap separates said outer layer from said inner layer sidewalls and said inner layer endwalls; and
said outer layer abuts said inner layer rear face.

17. The collar as in claim 16, wherein:
said inner layer of non-porous flexible plastic is a layer of polyvinyl chloride combined with a plasticizer; and
said outer layer of non-porous flexible plastic is a layer of polyvinyl chloride combined with a plasticizer.

18. The collar as in claim 17, further comprising an ornament, said inner layer being molded over said ornament and separating said ornament from said outer layer.

19. The collar as in claim 18, wherein:
said inner layer aesthetic property includes a first color; and
said outer layer aesthetic property includes a second color.

20. The collar as in claim 14, wherein:
said inner layer aesthetic property includes a first color; and
said outer layer aesthetic property includes a second color.
